(19) United States
(12) Patent Application Publication
(10) Pub. No.: US 2013/0007027 A1
(43) Pub. Date: Jan. 3, 2013

(54) IN-SITU SERIALIZATION SYSTEM USING META OBJECT MODELS AND METHODS THEREOF

(76) Inventors: Thomas M. Hazel, Andover, MA (US); Jason P. Jeffords, Bedford, NH (US)

(21) Appl. No.: 13/344,220

(22) Filed: Jan. 5, 2012

Related U.S. Application Data
(60) Provisional application No. 61/429,964, filed on Jan. 5, 2011.

(51) Int. Cl. G06F 17/30

(52) U.S. Cl. 707/756; 707/E17.005

(57) ABSTRACT

A method, system, and computer program product for in-situ serialization and deserialization of objects and/or types. A received object nad/or type is serialized by accessing a meta schema of cached object and type handlers formed as part of a run-time analysis of a plurality of such objects and types. Serialization is performed at run-time based on the meta schema, including referencing the cached plurality of handlers. A received object or type is deserialized by accessing a meta schema having similar cached object and type handlers formed as part of a run-time analysis of a plurality of objects and types. Deserialization is performed at run-time based on a serialization protocol and meta schema, including referencing the cached handlers.

### CROSS-REFERENCE TO RELATED APPLICATION(S)

This application claims the benefit of U.S. Provisional Application No. 61/429,964 entitled “IN-SITU SERIALIZATION USING META OBJECT MODELS” filed on Jan. 5, 2011, which is expressly incorporated by reference herein in its entirety.

### BACKGROUND

1. Field

The present disclosure relates generally to communication systems, and more particularly, relates to the serialization and deserialization of any object at run-time in a cloud-based environment, without modification of the original object model or source code.

2. Background

The “cloud” is a next generation computing system that provides elasticity in using physical and/or virtual servers. A cloud-based environment includes computing resources, both physical and virtual servers, that can be dynamically and rapidly scaled and that are available via a network. Thus, a cloud-based environment includes the centralization of computing resources over a network. This enables systems to be built out in a horizontal manner, and enables services on demand. The cloud includes servers and back end databases that are accessible via access points such as web browsers at an access device.

Cloud computing software systems typically include multiple cloud components communicating with each other over application programming interfaces, such as web services. Cloud computing includes Web-based processing. Shared resources, software and information can be provided to computers and other access devices on demand via the Internet.

Cloud computing provides a new delivery model for Information Technology (IT) services based on the Internet. Users can access web-based tools or applications via a web browser similar to the program being installed locally on their own computer.

Cloud computing architecture includes, e.g., a front end and a back end. The front end is seen by the client, i.e., the computer user. This front end includes the client's network (or computer) and the applications used to access the cloud via a user interface such as a web browser. The back end of the cloud computing architecture (e.g., the ‘cloud’ itself) includes computers, servers and/or data storage devices.

Cloud clients can include computer hardware and/or software that relies on cloud computing for application delivery or that is designed to deliver cloud services. This may include various access devices such as computers, telephones, operating systems, browsers, and other devices.

Cloud computing provides agility, improving with users' ability to rapidly and inexpensively re-provision technological infrastructure resources; reduced costs; scalability; and device and location independence, by enabling users to access systems using a web browser regardless of their location or what device they are using (e.g., personal computer (PC) or mobile devices). As infrastructure is off-site (typically provided by a third-party) and accessed via the Internet, users can connect from anywhere. Cloud computing also enables resources to be shared across a large pool of users.

Applications may be run on a single server that includes a third party system and source code. Cloud enabling such a system and source code, without making any changes to the third party system, requires a virtualization of the application in the cloud. Each system includes its own basic model and corresponding object data.

Typically, knowledge of a third party's source code is necessary to provide run-time information for and add behavior to a running system. However, when building systems that run in a cloud environment, it would be beneficial to provide tool chains that are quick and easy to use and that will work in connection with existing run-time systems without modification or access to original source code.

In the context of data storage and transmission, serialization is the process of converting a data structure or object into a format that can be stored or transmitted across a network connection and unconverted later in the same or another computer environment. This process of serializing an object is also called deflating or marshalling an object. The opposite operation to serialization, extracting a data structure from a series of bytes, is called deserialization.

Current serialization mechanisms require explicit specification of serialization through object model modifications. This approach creates a static set of code that may not be applicable to future object models or serialization protocols (e.g., “on-the-wire” formats). Thus, there is a need in the art for a serialization mechanism/protocol that is highly efficient in both time and space and that works with any object model.

### SUMMARY

In light of the above described problems and unmet needs, systems and methods are provided for in-situ serialization and deserialization using meta object models. Aspects of the invention may include analysis and traversal of object models for third party systems and source code that can be made at run-time without the need for access to the original object model or source code. Among other things, this approach allows cloud-based tools for serialization and deserialization to be provided without direct access to the third party source code and without making any changes to the third party system.

Aspects provide a general solution for serialization/deserialization that can be applied to any object, e.g., whether from a third party system or not. Aspects provide very high performance both in time efficiency and in the efficient use of storage and transmission space. Aspects are applicable to both message passing and persistence (e.g., disk, database, etc.). Further, in-band schema aspects with compression support run-time dynamic schema exchange, evolution, and lossless information transfer.

Aspects may include, for example, a method, system, and computer program product for performing in-situ serialization of an object or type. An object and/or type is received, and a meta schema comprising a plurality of cached object and type handlers is accessed. The meta schema is formed as part of a run-time analysis of a plurality of objects and types. Via a processing device, serialization is performed at run-time based on the meta schema, wherein performing serialization includes referencing the cached plurality of handlers.

Additional aspects may include, for example, a method, system, and computer program product for performing of in-situ deserialization of a serialized object or type. A serialized item, e.g., an object or type, is received, and a meta schema is accessed. The meta schema comprises a plurality of cached object and type handlers formed as part of a run-time analysis of a plurality of objects/types. Via a processing device, deserialization is performed at run-time based on the serialization protocol and meta schema, wherein performing deserialization includes referencing the cached plurality of handlers.

The object or type may be received from a third party or other system. By using a meta schema that is formed as part of a run-time analysis of other objects and types, the serialization or deserialization may be performed without accessing an object model or source code from the source of the object or type. Likewise, multiple serialization formats and protocols may be supported. The serialization and deserialization may be performed in a cloud-based environment, and the meta schema may be cached in a cloud-based environment.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

Various aspects of the systems and methods will be described in detail, with reference to the following figures, wherein:

FIG. 1 illustrates an example aspect of a cloud computing system;

FIG. 2 presents an example system diagram of various hardware components and other features, for use in accordance with aspects of the present invention;

FIG. 3 is a block diagram of various example system components, in accordance with aspects of the present invention;

FIGS. 4A-4B illustrates a flow chart of aspects of serialization in accordance with aspects of the present invention;

FIG. 5 illustrates a flow chart of aspects deserialization in accordance with aspects of the present;

FIGS. 6A-B illustrate a flow chart with aspects of deserialization in accordance with aspects of the present invention;

FIG. 7 illustrates a flow chart with aspects of serialization in accordance with aspects of the present invention; and

FIG. 8 illustrates a flow chart with aspects of deserialization in accordance with aspects of the present invention.

### DETAILED DESCRIPTION

These and other features and advantages of this invention are described in, or are apparent from, the following detailed description of various example illustrations and implementations.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of systems capable of interacting in a cloud-based environment will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented using a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example illustrations, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), Electrically Erasable Programmable ROM (EEPROM), compact disk (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

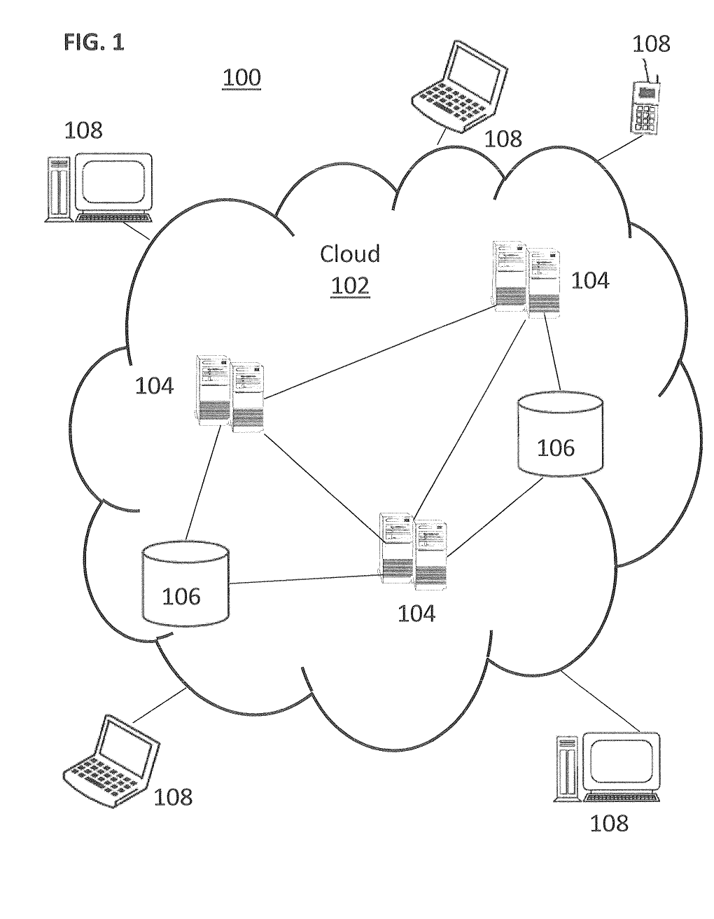

FIG. 1 illustrates aspects of a cloud based computing environment 100. The “cloud” 102 includes various servers 104 and databases 106 that provide services to various users 108 via a connection to the Internet.

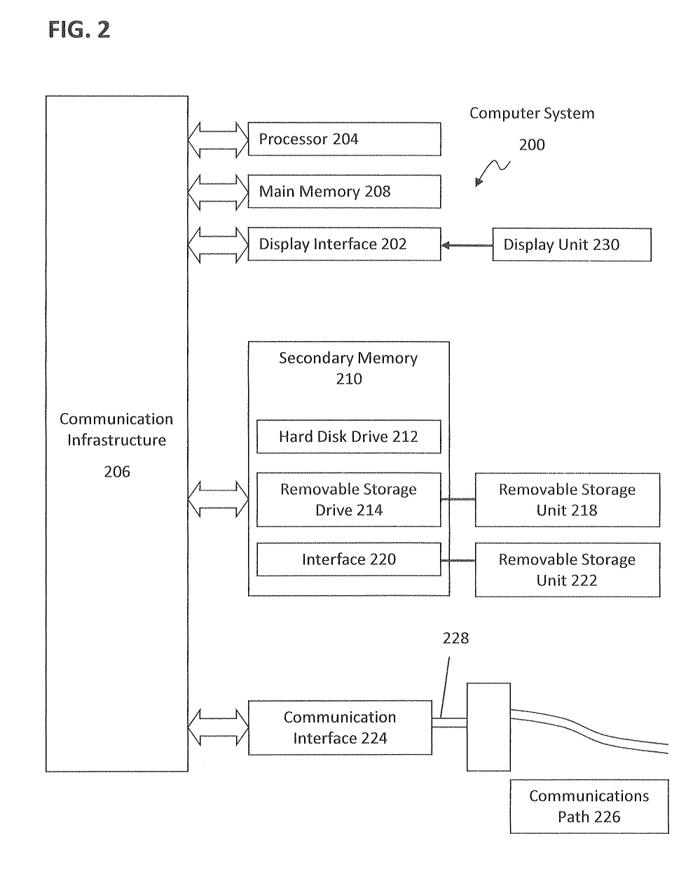

FIG. 2 presents an example system diagram of various hardware components and other features, for use in accordance with an implementation of the present invention.

The present invention may be implemented using hardware, software, or a combination thereof, and may be implemented in one or more computer systems or other processing systems. In one implementation, the invention is directed toward one or more computer systems capable of carrying out the functionality described herein. An example of such a computer system 200 is shown in FIG. 2.

Computer system 200 includes one or more processors, such as processor 204. The processor 204 is connected to a communication infrastructure 206 (e.g., a communications bus, cross-over bar, or network). Various software implementations are described in terms of this example computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on a display unit 230. Computer system 200 also includes a main memory 208, preferably RAM, and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative implementations, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an EPROM, or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 210 to perform the features of the present invention. Accordingly, such computer programs represent controllers of the computer system 200.

In an implementation where the invention is implemented using software, the software may be stored in a computer program product and loaded into computer system 200 using removable storage drive 214, hard drive 212, or communications interface 220. The control logic (software), when executed by the processor 204, causes the processor 204 to perform the functions of the invention as described herein. In another implementation, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another implementation, the invention is implemented using a combination of both hardware and software.

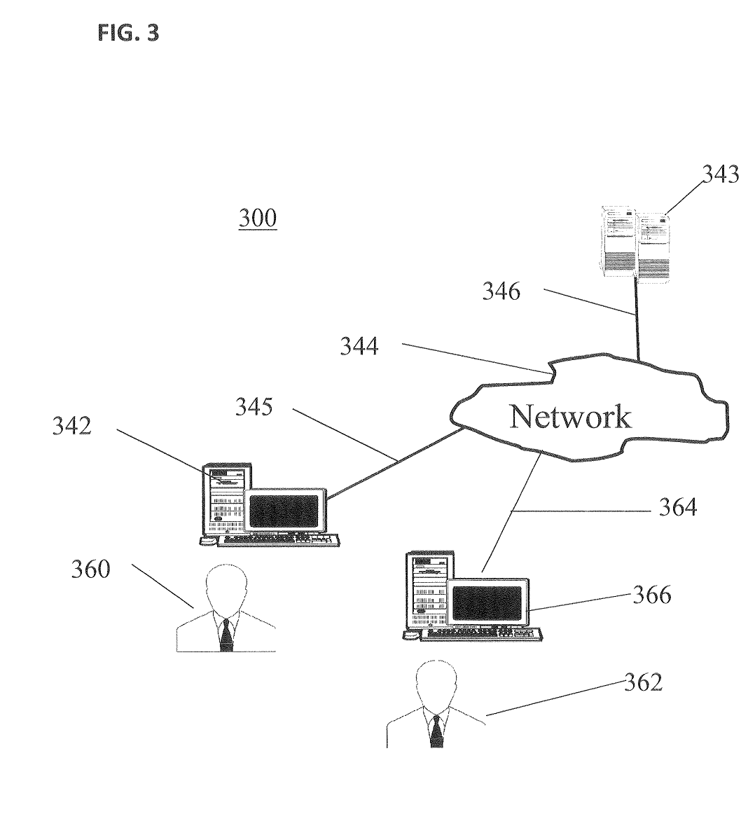

FIG. 3 is a block diagram of various example system components, in accordance with aspects of the present invention. FIG. 3 shows a communication system 300 usable in accordance with the aspects presented herein. The communication system 300 includes one or more accessors 360, 362 (also referred to interchangeably herein as one or more “users” or clients) and one or more terminals 342, 366. In an implementation, data for use in accordance with aspects of the present invention may be, for example, input and/or accessed by accessors 360, 364 via terminals 342, 366, such as personal computers (PCs), minicomputers, mainframe computers, microcomputers, telephonic devices, or wireless devices, such as personal digital assistants (“PDAs”) or a hand-held wireless devices coupled to a server 343, such as a PC, minicomputer, mainframe computer, microcomputer, or other device having a processor and a repository for data and/or connection to a repository for data, via, for example, a network 344, such as the Internet or an intranet, and couplings 345, 346, 364. The couplings 345, 346, 364 include, for example, wired, wireless, or fiberoptic links.

Serialization is a fundamental component in all computing systems exchanging information. Serialization is the transformation of objects to bytes, and deserialization is the reverse process. Typically, of importance is a serialization mechanism and/or protocol that is high performance (both in time and in space), works with any object model (e.g., no object model changes are required to support serialization) and is self-describing (e.g., to support dynamic schema exchange and evolution). Without these features, large scale, distributed systems become much harder to build and maintain, inherently limiting their wide-spread adoption, use and scale.

Virtually all communication of information between, and often within, systems requires serialization. Among other things, aspects presented herein solve the problem of serialization in a generalized manner for systems where In-Place Object Model Analysis and Traversal is performed. In-Place Object Model Analysis and Traversal is described in further detail in U.S. application Ser. No. 13/327,923, filed on Dec. 16, 2011, titled IN-PLACE OBJECT MODEL ANALYSIS AND TRAVERSAL SYSTEM AND METHOD THEREOF, the entire contents of which are incorporated herein by reference.

Aspects provide a general solution for serialization/deserialization that can be applied to any object. Aspects provide very high performance both in time efficiency and in the efficient use of storage and transmission space. Aspects are applicable to both message passing and persistence (e.g., disk, database). Further, in-band schema aspects with compression support runtime dynamic schema exchange, evolution, and lossless information transfer.

Related art serialization systems require explicit specification of serialization through object model modifications, among other disadvantages. Aspects presented herein enable serialization of any suitable object without object model modifications. The in-situ serialization presented herein leverages the meta object model created through in-place object model analysis and traversal, e.g., as described in U.S. application Ser. No. 13/327,923, to perform serialization and deserialization operations for arbitrary object models.

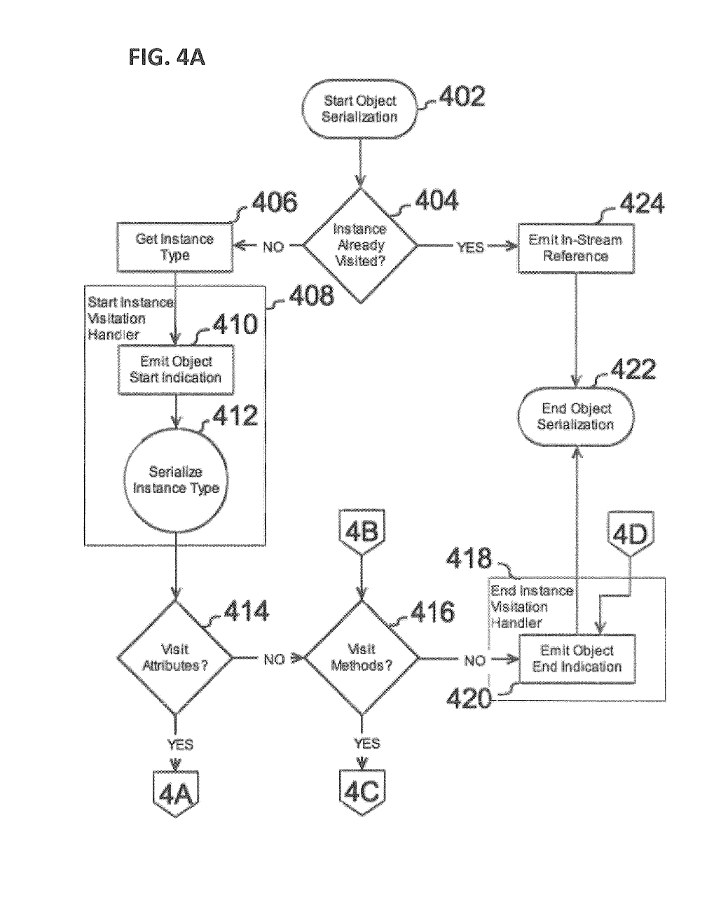

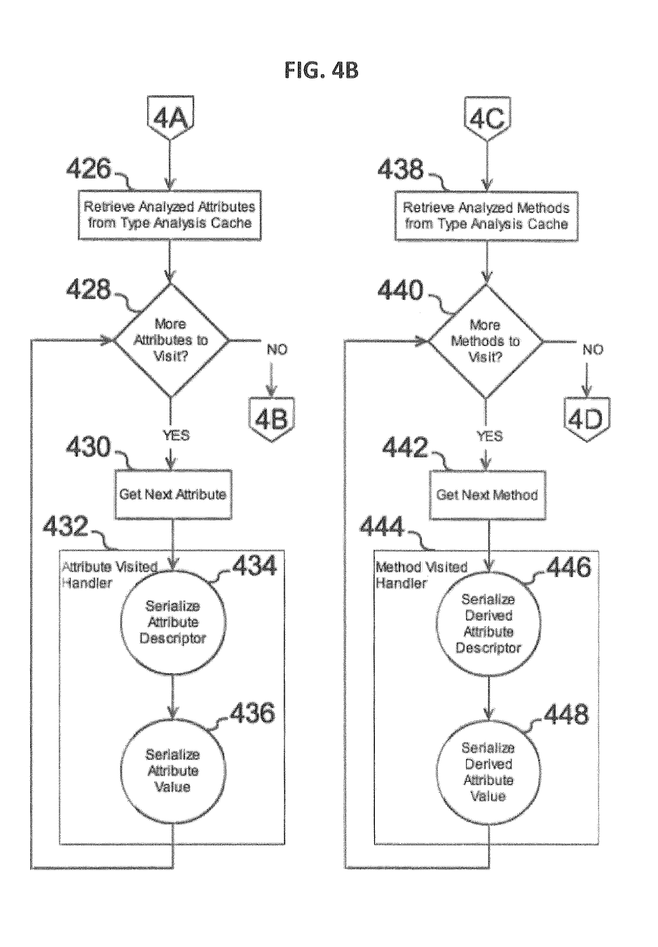

FIGS. 4A and 4B illustrate aspects of such serialization in accordance with an example implementation of a variation of the present invention. At 402, object serialization starts for a particular object. At 404, it is determined whether or not this instance of the object has previously been visited. If the instance has previously been visited, the in-stream reference for the object is emitted at 424, and object serialization is ended. This operation can be an important aspect that prevents the reserialization of previously visited instances by emitting a notification that the object does not need to be serialized again. In turn, this notification can be used to emit an in-stream reference to the previously serialized instance, implementing both compression and enforcing referential integrity.

However, if the instance has not previously been visited, at 406, the instance type is obtained. At 408, the instance visitation handler is called. This handler is described in further detail in U.S. application Ser. No. 13/327,923. Step 408 may include emitting/sending an object start indication 410. However, this operation depends on the particular serialization protocol. A serialization protocol may also serialize an object without such an emission. At 412, the instance type is serialized based on the called handler. Schema may continuously be placed in a transmission stream. At 414, it is determined whether the attributes of the object are to be visited. If not, then it is determined at 416 whether the methods should be visited. If not, then the process moves to 418, where the end instance visitation handler is called. This handler may then emit a protocol dependent, object end indication 420. However, if the protocol does not require object end indication, such an indication may be omitted.

Visitation and serialization of attributes and methods in connection with the object are programmable based on the desired type of serialization. For example, FIG. 4B illustrates that if attributes are to be visited at 414, at 426, analyzed attributes are retrieved from a type analysis cache. At 428, a determination is made as to whether additional attributes are to be visited. If there are additional attributes to visit, the next attribute is obtained at 430, and the attribute visited handler is called at 432. At 434, the attribute descriptor is serialized, and at 436, the attribute value is serialized. This approach continues recursively until all attributes have been visited. Then a determination is made regarding visiting methods. If there are methods to be visited, the analyzed methods are retrieved from the type analysis cache in 438. Similar to the process for steps 430-436, each method is obtained, the method visited handler is called, the derived attribute descriptor is serialized, and the Derived attribute value is serialized.

When visiting attributes and methods may include at least two types of handlers: (1) Global/type based where each attribute/method visited will be “passed through” a global/type based handler; and (2) per attribute/method where each attribute/method has a specific handler that is called as it is visited. Global/type based handlers may implement per-attribute/method handlers or the per-attribute/method may be implemented separately (attached to the meta schema).

The attribute and method portion of the serialization may be dependent on the protocol for serialization. This possibility also depends on the manner in which the handler hooks are written. For example, the attribute descriptor may be null, and, in this event, the attribute descriptor will not be included as part of the serialization.

Although FIGS. 4-6 have been described in connection with an object, it is noted that a type can be serialized in a similar manner to that described for an object.

FIGS. 4A and 4B illustrate a serialization structure that is not tied to a specific set of code that is written at a specific date. Rather, in FIGS. 4A and 4B, the serialization protocol can be updated and modified. By incorporating the run-time type object model analysis, serialization can be performed for any object, even those that may be created in the future, because the serialization incorporates caches that can be continuously updated. Further, the serialization is independent of the format type, it is equally applicable to XML, JSON, binary, and standard Java serialization, among others. The serialization provides an on-the-wire format that can adapt to new object models at any suitable time. Thus, the serialization process can respond to schema changes dynamically at run-time, rather than being based statically, for example, on compile time. For example, a specific mechanism for a current object can be created at run-time. There is no need to put specific code in place prior to any serialization of the object.

In-band schema allows a byte stream (the serialized representation of objects) to be self describing. This self describing property allows objects to be de-serialized, held and re-serialized, for example, without information loss, even in systems without matching schemas.

References can be as analogized to pointers to objects. In order for a reference to be useful its context must be known. In some variations, at least two contexts can be supported, e.g. in-stream and out-of-stream.

In stream references may point to objects within a stream. For simplicity in this description, they may be described generally as back-references (e.g., they are pointing to objects that have already been serialized).

Out-of-stream references may point to objects outside the stream, for example. Their context can either be explicit (as is the case of an Uniform Resource Identifier “URI”) or implicit (as is the case of an Uniform Unique Identifier “UUID”). When serializing an object represented by an out-of-stream object reference, the reference may be sent instead of the entire object. When de-serializing an out-of-stream object reference, the reference object may be looked up by reference and/or a reference object may be instantiated (e.g., depending on the semantics of the object model).

A provision can also be made for serialization control within serialization streams.

A long-lived serialization stream could contain a very large number of objects and in-stream references. As this number increases, the in-stream reference space may become arbitrarily large. Thus, a provision can be made for resetting the in-stream references and clearing the reference cache.

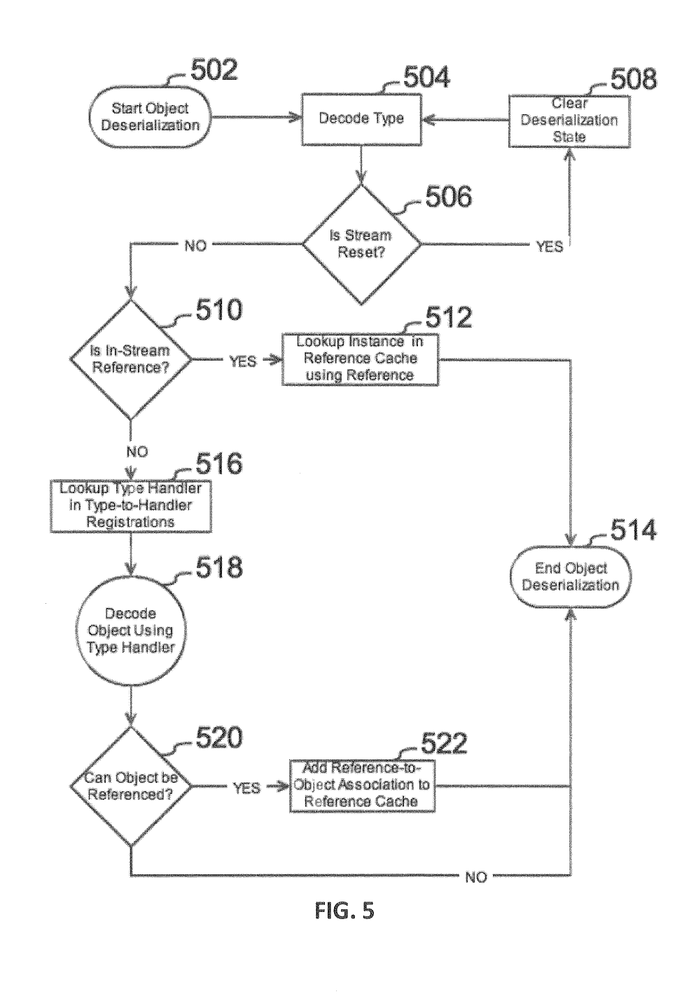

FIG. 5 illustrates aspects of deserialization, in accordance with an exemplary implementation of the present invention. Initially, a serialized object is obtained. At 502, object deserialization is begun. At 504, the object type is decoded from the transmission stream. At 506, it is determined whether the type is a stream reset. If the type is a stream reset, at 508, the deserialization state is cleared. A stream reset is a special type that enables the management of recorded states. For example, if a serialized object's state changes, the cache related to that object's state needs to be cleared, in order to prevent a stale cache having outdated information. By providing a stream reset and first determining whether the stream includes a stream reset, the state cache can be maintained more precisely. Both global and per-object reference stream resets are supported. Additional stream control and/or stream reset policies can be incorporated. For example, a policy may be implemented that bounds or limits the number of allowed in-stream references to a predetermined number. In this example, when the predetermined limit is reached, the first reference is replaced with the latest serialized object. As another example, a policy may be implemented that enables multiple in-stream reference spaces. Again, a predetermined number of reference spaces may be enabled, each for a different context, e.g., one space may be provided for schema instances and another for program objects.

If the type is not a stream reset, at 510, a determination is made as to whether there is an in-stream reference. If an in-stream reference exists for the object, at 512, the instance is looked up in a reference cache using the reference in order to obtain the object from the serialized data. At 514, the object serialization is finished.

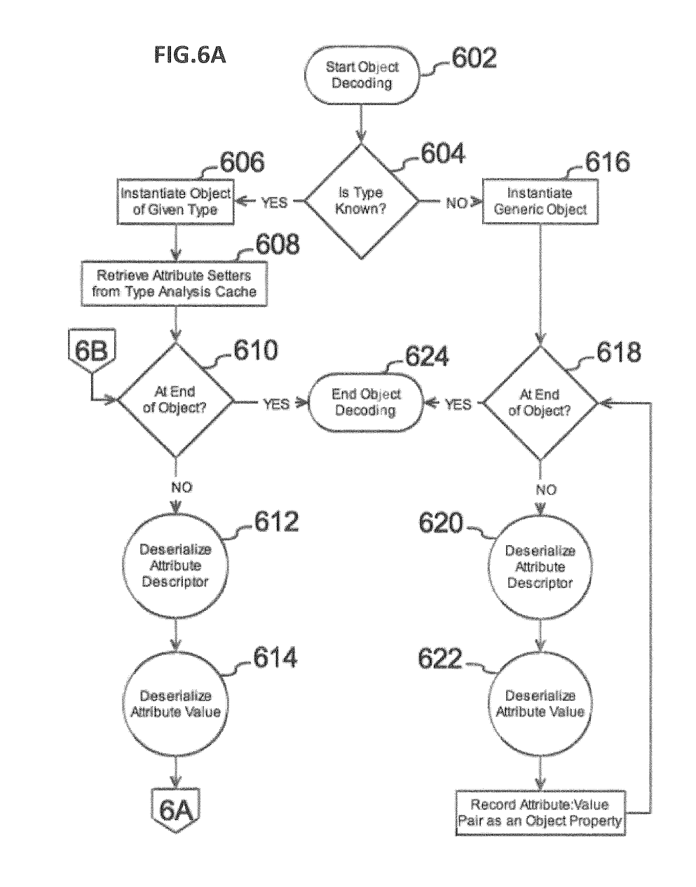

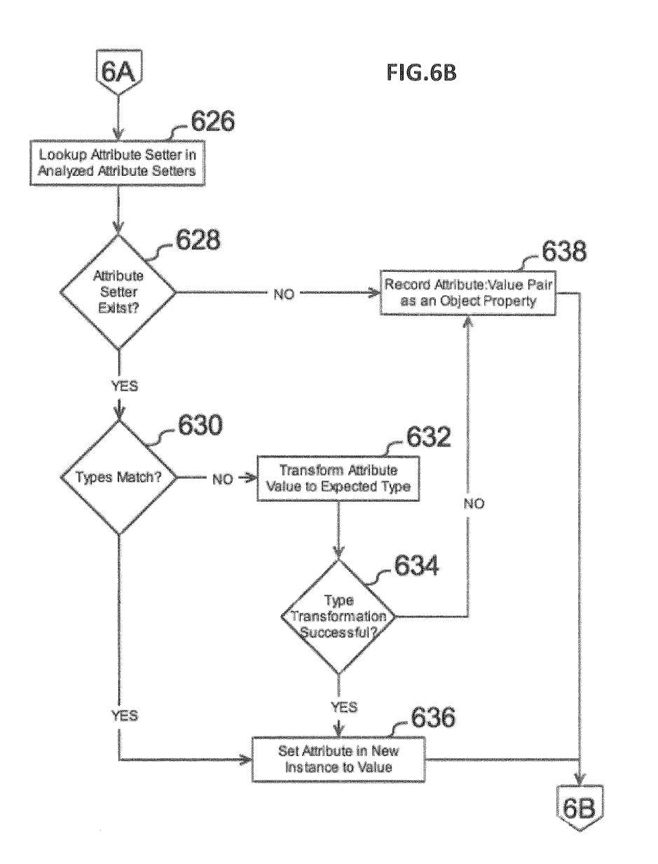

If there is no in-stream reference, at 516, the type handler is looked up in the Type-to-Handler Registration. This Registration may have been previously generated, for example, as described in further detail in U.S. application Ser. No. 13/327,923, and may provide information on how to handle the particular type of object. This approach may inform the manner in which such an object type should be deserialized. At 518, the object is decoded using the type handler obtained in 516. An exemplary decoding process, in accordance with that illustrated by 518, is described in more detail in connection with FIGS. 6A and 6B.

At 520, a determination is made as to whether the object can be referenced. If the object can be referenced, a reference for the object is added to the reference cache at 522, and object deserialization is ended at 514. Then, if the serialized information for the object is received again, deserialization will involve looking up the instance in the reference cache, i.e. 512, rather than performing deserialization as in steps 516 and 518.

Certain types of primitive objects do not lend themselves to such a reference. For these objects, no reference may be added to the reference cache, and the object deserialization may end at 514.

FIGS. 6A and 6B illustrate aspects of deserialization related to step 518 from FIG. 5. At 602, object decoding is begun. At 604, a determination is made as to whether the type is known. If the given type is known, at 606, the object of the given type is instantiated. Instantiation depends on the language being used. For example, instantiation may involve registering instantiation handlers for each type as part of the meta object schema. Thus, object instantiation can be performed via type instantiation handlers. Then, at 608, attribute setters are retrieved from a type analysis cache. An attribute setter is a handler that, e.g., takes an object and an attribute value and sets the object's attribute to that value. By going to a cache in order to retrieve attribute setters, the method and system can be generalized to deal with any appropriate object type. This information may be precompiled as a part of object analysis. However, such analysis may be performed at run-time, rather than requiring a hard coded set of instructions that is prepared at compile time.

At 610, a determination is made as to whether the end of the object has been obtained. At the end of the object, object decoding is finished at 624. Then, the determination at 520 may be made, e.g., a determination as to whether the object can be referenced. If it is determined that the object is not at the end, an attribute descriptor deserialization may be performed at 612 and an attribute value deserialization may be performed at 614. Note that both deserializations are recursive and start, for example, at 502 in FIG. 5. The attribute descriptor deserialization may be required or skipped based, for example, on the desired deserialization protocol. After steps 612 and 614, the process moves to 626, illustrated in FIG. 6B. At 626, the attribute setter is looked up among a cache of Analyzed Attribute Setters. Among other things, this approach enables a knowledge of what setter to use based either on a sequential protocol or based on specific attributes. At 628, it is determined whether a corresponding attribute setter exists. If such as setter exists, at 630, it is determined whether the type is required by the serialized stream matches the type in the attribute setter. If the types match, the attribute is set in a new instance to the determined value at 636.

If the types do not match, the attribute value is transformed to the expected type at 632. At 634, a determination is made regarding whether the type transformation was successful. If the transformation was successful, the attribute is set in a new instance to the determined value at 636.

If the transformation is unsuccessful, an attribute:value pair is recorded as an object property at 638. Such an attribute:value pair is also recorded as an object property if it is determined at 628 that an attribute setter does not exist. This approach enables information to be preserved when the schema does not match and it might be detrimental to lose such non-conforming information.

The analysis then returns to 610 to determine if the end of the object has been reached. If it has not, the process continues until the end is reached.

If it is determined at 604 that the type is not known, a generic object is instantiated at 616. This operation provides a mechanism for holding an object as a generic object, among other things, in order to transport unknown objects through the deserialization process. Thus, even if the object type is unknown, deserialization may be performed. At 618, a determination is made as to whether the end of the object has been obtained. At the end of the object, object decoding is finished at 624. Then, the determination at 520, e.g., as illustrated in FIG. 5, may be made. If it is determined that the object is not at the end, an attribute descriptor deserialization may be performed at 620, and an attribute value deserialization may be performed at 622. Note that both deserializations are recursive and start at 502 from FIG. 5. The attribute descriptor deserialization may be required or skipped based on the desired deserialization protocol. Then, the attribute:value pair is recorded as an object property for the generic object, and the process continues recursively until the end of the object is reached.

A generic object may become a container for attributes and values. Such an object may include a type and hold corresponding attributes and value information.

By including provisions for unknown or generic types, the deserialization process can be applied even if deserialization instructions regarding the unknown type have not been previously compiled.

Thus, aspects include obtaining run-time object information from a third party system and performing run-time serialization/deserialization based on a meta schema formed as part of a run-time analysis of a plurality of objects, including referencing a cache of Handlers related to objects from such third party systems.

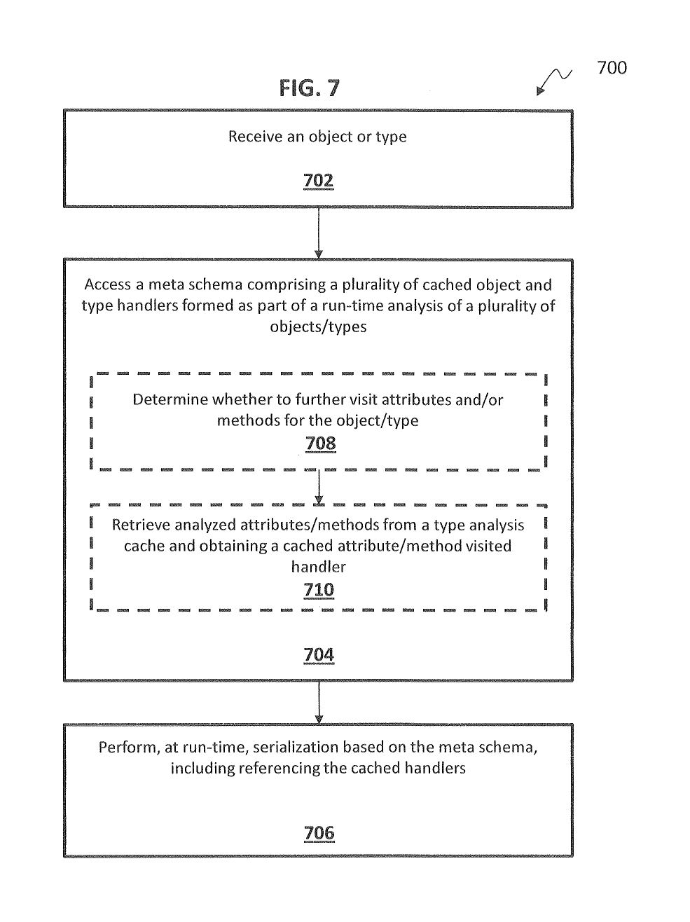

FIG. 7 illustrates a flow chart illustrating aspects of an automated method 700 of in-situ serialization of an item (e.g. object and/or type). At 702, an object or type is received. At 704, a meta schema is accessed. The meta schema includes cached object and type handlers formed as part of a run-time analysis of objects and types.

Then, at 706, serialization is performed, at run-time, based on the meta schema. Serialization is performed via a processing device, and performing serialization includes referencing the cached plurality of handlers.

The serialization may be performed in a cloud-based environment, and the meta schema may be cached in the cloud-based environment. The object and/or type may be received, e.g., from a third party system and may be received from such a third party system at run-time. The object and/or type may also be received from non-third party systems. Serialization can be performed without accessing an object model or source code from the corresponding system, e.g., third party system from which the object and/or type was received. Serialization can be performed without using a third party serialization method.

A plurality of serialization formats and protocols can be supported, the serialization formats and protocols being determined by serialization handlers at run-time.

Aspects may further include determining whether an instance for the object and/or type has been previously visited and, when it is determined that an instance for the object and/or type has been previously visited, emitting an in-stream reference for the object and/or type.

The method may also include substituting items with out-of-stream references at serialization time. When an item is deserialized, out-of-stream references are substituted with their corresponding items or item references. This preserves referential integrity across serialization session boundaries (e.g., messages) and allows the serialization of partial object graphs.

Aspects may further include determining whether to further visit attributes and/or methods for the object and/or type, as illustrated at step 708. When it is determined to visit attributes for the object and/or type, analyzed attributes are retrieved from a type analysis cache and obtaining a cached attribute visited handler, and when it is determined to visit methods for the object and/or type, analyzed methods are retrieved from a type analysis cache and obtaining a cached method visited handler, as illustrated at 710.

When visiting attributes and methods there are two types of handlers: (1) Global/type based handler where each attribute/method visited will be “passed through” a global/type based handler, and (2) per attribute/method handler where each attribute/method has a specific handler that is called as it is visited. Global/type based handlers may implement per-attribute/method handlers or the per-attribute/method may be implemented separately (attached to the meta schema). FIG. 4B illustrates the two types of handlers.

When it is determined to visit attributes for the object and/or type, an attributes visited handler is obtained for each attribute of the object and/or type and the attribute descriptor and/or the attribute value for the object and/or type are serialized. Similarly, when it is determined to visit methods for the object and/or type, a methods visited handler is obtained for each method of the object and/or type, and the derived attribute descriptor and/or the derived attribute value for the object and/or type is serialized.

As noted above, the object and/or type may comprise multiple attributes and methods. A unique handler may be obtained for each of the attributes and methods of the object and/or type and used in either serialization or deserialization.

Aspects may further include receiving a serialized object and/or type, the serialized object and/or type encoded according to a serialization protocol and, via the processing device, performing deserialization at run-time based on the serialization protocol and meta schema.

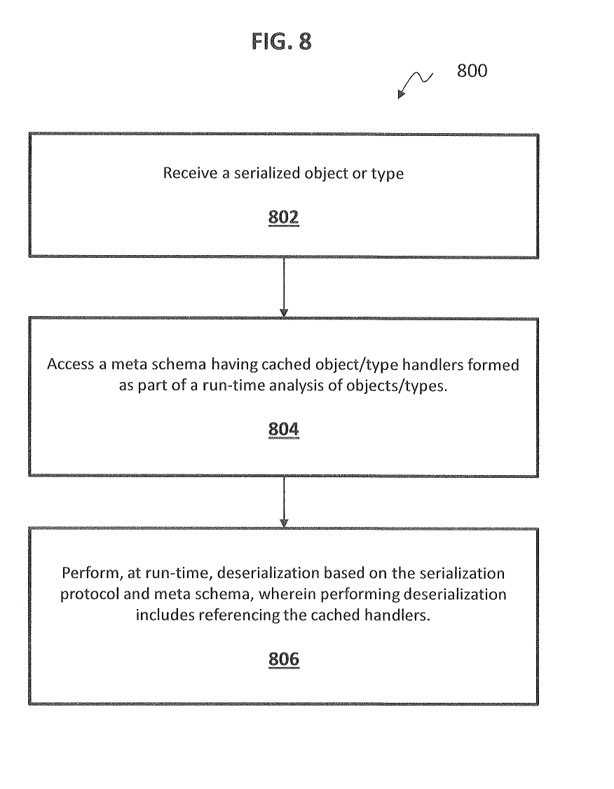

FIG. 8 is a flow chart illustrating aspects of an automated method of in-situ deserialization of a serialized object and/or type. At step 802, a serialized object and/or type is received. The object and/or type may be received from a third party system. Object information from the third party system may be obtained at run-time.

At 804, a meta schema is accessed, the meta schema having cached object and type handlers formed as part of a run-time analysis of a plurality of items (i.e. objects/types). The items may be items from third party systems.

At 806, deserialization is performed at run-time based on the serialization protocol and meta schema, via a processing device. Performing deserialization includes referencing the cached plurality of handlers. Deserialization may be performed without accessing an object model or source code from the third party system for the object and/or type.

The deserialization of the received object and/or type may be performed at run-time in a cloud-based environment. The cached meta schema may be cached in the cloud-based environment.

Aspects may further include determining whether the serialized object and/or type is an in-stream reference and determining whether an instance for that reference exists in a reference cache. When an in-stream reference exists for the object and/or type, deserializing the object and/or type by obtaining the corresponding instance in the reference cache.

Aspects may further include obtaining a handler in a cache of object and/or type-to-handler registrations, when an in-stream reference does not exist for the object and/or type, deserializing the object and/or type by decoding the object and/or type using the handler, determining whether the object and/or type can be referenced, and when the object and/or type can be referenced, adding a reference associated with the object and/or type to the reference cache.

Decoding the object and/or type using the handler may include determining whether the type is known. When it is determined that the type is known, aspects may further include retrieving attribute setters from a type analysis cache and deserializing the object and/or type using the retrieved attribute setters.

Deserializing the object and/or type may include deserializing at least one of an attribute descriptor and an attribute value for the object and/or type using the retrieved attribute setters.

Aspects may further include determining whether an attribute setter exists for the object and/or type. When it is determined that an attribute setter does not exist for the object and/or type, aspect may further include recording an attribute:value pair as an object and/or type property attached to the object and/or type.

Decoding the object and/or type using the handler may include determining whether the object and/or type is known. When it is determined that the object and/or type is not known, aspects may further include deserializing the attribute descriptor and the attribute value for the object and/or type and recording the attribute:value pair as an object and/or type property attached to the object and/or type.

Aspects may further include determining whether the item is a stream reset. When it is determined that the object and/or type is a stream reset, aspects may include clearing a deserialization state.

When unknown objects/types are received, a generic object is instantiated during deserialization as a placeholder for such unknown types. This preserves the data for the unknown object and/or type so that information transfers can be lossless.

In addition, when attributes are deserialized, the types of the attributes that do not match the expected type from the meta schema for the object, a type transformation is performed, if possible. However, at times, type transformation will not be possible. When this occurs, the attribute:value is stored as a property on the item (e.g., object or type). This enables schema evolution and operation in a distributed environment having components at different versions.

By providing such a generalized in-situ serialization/deserialization solution enables many different, pluggable serialization formats and protocols (i.e. on-the-wire representations) to be applied. The protocols and representations can be self describing, such that they embed schema meta data.

During serialization and deserialization, a subset of attributes/methods may be serialized and deserialized. By serializing/deserializing such a subset, enables only changed attributes/methods to be serialized, transferred, and then deserialized. This enables compact object change notification, thereby increasing the efficiency of such a system. This becomes possible, at least in part, because of the ability to embed schema meta data, e.g. in the self-describing protocols and representations.

While this invention has been described in conjunction with the example aspects of implementations outlined above, various alternatives, modifications, variations, improvements, and/or substantial equivalents, whether known or that are or may be presently unforeseen, may become apparent to those having at least ordinary skill in the art. Accordingly, the example illustrations, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A computer assisted method of in-situ serialization of an item, the method comprising:
receiving the item, the item comprising at least one selected from a group consisting of an object and a type;
accessing a meta schema comprising a plurality of cached object and type handlers formed as part of a run-time analysis of a plurality of items;
via a processing device, performing, at run-time, serialization based on the meta schema, wherein performing serialization includes referencing the cached plurality of handlers.

2. The method of claim 1, wherein the item is received from a third party system.

3. The method of claim 2, wherein the item is obtained at run-time, and wherein the serialization is performed without accessing an object model or source code from the third party system for the item.

4. The method of claim 1, wherein serialization is performed via the processing device without using a third party serialization method.

5. The method of claim 1, wherein a plurality of serialization formats and protocols are supported, the serialization formats and protocols being determined by serialization handlers at run-time.

6. The method of claim 5, wherein the protocols are self-describing.

7. The method of claim 6, wherein serializing the item comprises:
serializing a subset of attributes and/or methods for the item, wherein the subset includes an empty set; and
transmitting the serialized item.

8. The method of claim 1, further comprising:
determining whether an instance for the item has been previously visited; and
when it is determined that an instance for the item has been previously visited, emitting an in-stream reference for the item.

9. the method of claim 8, further comprising:
when it is determined that an instance for the item has not been previously visited, substituting an out-of-stream reference for the item.

10. The method of claim 1, further comprising:
determining whether to further visit at least one selected from a group consisting of attributes and methods for the item;
when it is determined to visit attributes for the item, retrieving analyzed attributes from a type analysis cache and obtaining a cached attribute visited handler; and
when it is determined to visit methods for the item, retrieving analyzed methods from a type analysis cache and obtaining a cached method visited handler.

11. The method of claim 10, further comprising:
when it is determined to visit attributes for the item:
obtaining an attributes visited handler for each attribute of the item; and
serializing at least one selected from a group consisting of the attribute descriptor and the attribute value; and
when it is determined to visit methods for the item:
obtaining a methods visited handler for each method of the item; and
serializing at least one selected from a group consisting of the derived attribute descriptor and the derived attribute value.

12. The method of claim 11, wherein each of a plurality of attributes for the item has a unique attribute visited handler and wherein each of a plurality of methods for the item has a unique method visited handler.

13. The method of claim 1, wherein the method further comprises:
receiving a serialized item, the serialized item being encoded according to a serialization protocol;
via the processing device, performing deserialization at run-time based on the serialization protocol and meta schema.

14. The method of claim 1, wherein serializing the item at run-time is performed in a cloud-based environment, and wherein the cached meta schema is cached in the cloud-based environment.

15. The method of claim 1, further comprising:
performing stream control based on a stream control policy.

16. The method of claim 15, wherein the stream control policy includes at least one of a predetermined limit on allowed in-stream references and a predetermined number of in-stream reference spaces.

17. A computer-assisted method of in-situ deserialization of a serialized item, the method comprising:
receiving the serialized item, the serialized item comprising at least one selected from a group consisting of an object and a type;
accessing a meta schema comprising a plurality of cached object and type handlers formed as part of a run-time analysis of a plurality of items from third party systems;
via a processing device, performing, at run-time, deserialization based on a serialization protocol and the meta schema, wherein performing deserialization includes referencing the cached plurality of handlers.

18. The method of claim 17, wherein the serialization protocol is self-describing.

19. The method of claim 18, wherein the received serialized item includes a subset of serialized attributes and/or methods for item, and wherein deserializing the item comprises
deserializing the subset of attributes or methods for the item.

20. The method of claim 17, wherein the item is received from a third party system.

21. The method of claim 17, wherein the item has an item type, and wherein performing deserialization comprises:
determining whether the item type is known;
when the type is known, instantiating an object of the type; and
when the type is not known, instantiating a generic object,
wherein object instantiation is performed via type instantiation handlers.

22. The method of claim 17, further comprising:
determining whether the deserialized item is an in-stream reference;
determining whether an instance for that reference exists in a reference cache; and
when an in-stream reference exists for the item, deserializing the item by obtaining the corresponding instance in the reference cache.

23. The method of claim 22, further comprising:
determining whether an out-of-stream reference exists for the item; and
when an out-of-stream reference exists for the item, substituting a corresponding item reference for the out-of-stream reference.

24. The method of claim 22, further comprising:
when an in-stream reference does not exist for the item, obtaining a handler in a cache of item type-to-handler registrations;
deserializing the item by decoding the item using the handler;
determining whether the item can be referenced; and
when the item can be referenced, adding a reference associated with the item to the reference cache.

25. The method of claim 24, wherein decoding the item using the handler includes determining whether the item type is known, the method further comprising:
when it is determined that the item type is known, retrieving attribute setters from a type analysis cache and deserializing the item using the retrieved attribute setters.

26. The method of claim 25, wherein deserializing the item includes deserializing at least one of an attribute descriptor and an attribute value for the item using the retrieved attribute setters.

27. The method of claim 25, further comprising:
determining whether an attribute setter exists for the item; and
when it is determined that an attribute setter does not exist for the item, recording an attribute:value pair as an item property attached to the item.

28. The method of claim 27, wherein, when it is determined that an attribute setter does exist for the item, the method further comprising:
determining whether an attribute type for the item matches an expected attribute type; and
when the attribute type for the item does not match an expected attribute type, performing a type transformation.

29. The method of claim 28, wherein when the type transformation cannot be performed, the method further comprises storing an attribute:value as an item property attached to the item.

30. The method of claim 24, wherein decoding the item using the handler includes determining whether the item is known, the method further comprising:
when it is determined that the item is not known, deserializing the attribute descriptor and the attribute value for the item and recording the attribute:value pair as an item property attached to the item.

31. The method of claim 24, wherein decoding the item using the handler includes determining whether the item type is known, the method further comprising:
when it is determined that the item type is not known, instantiating a generic object for the unknown item type.

32. The method of claim 17, further comprising:
determining whether the item is a stream reset; and
when it is determined that the item is a stream reset, clearing a deserialization state.

33. The method of claim 17, wherein the object information from the third party system is obtained at run-time, and wherein the deserialization is performed without accessing an object model or source code from the third party system for the item.

34. The method of claim 17, wherein deserializing the received third party item at run-time is performed in a cloud-based environment, and wherein the cached meta schema is cached in the cloud-based environment.

35. The method of claim 17, further comprising:
performing stream control based on a stream control policy.

36. The method of claim 35, wherein the stream control policy includes at least one of a predetermined limit on allowed in-stream references and a predetermined number of in-stream reference spaces.

37. An automated system for in-situ serialization of an item, the system comprising:
means for receiving the item, the item comprising at least one selected from a group consisting of an object and a type;
means for accessing a meta schema comprising a plurality of cached object and type handlers formed as part of a run-time analysis of a plurality of items;
means for performing, at run-time, serialization based on the meta schema, wherein performing serialization includes referencing the cached plurality of handlers.

38. An automated system for in-situ serialization of an item, the system comprising:
at least one processor;
a user interface functioning via the at least one processor; and
a repository accessible by the at least one processor; wherein the at least one processor is configured to:
receive the item, the item comprising at least one selected from a group consisting of an object and a type;
access a meta schema comprising a plurality of cached object and type handlers formed as part of a run-time analysis of a plurality of items;
via the at least one processor, perform, at run-time, serialization based on the meta schema, wherein performing serialization includes referencing the cached plurality of handlers.

39. A computer program product comprising a computer readable medium having control logic stored therein for causing a computer to perform in-situ serialization of an item, the control logic code for:
receiving the item, the item comprising at least one selected from a group consisting of an object and a type;
accessing a meta schema comprising a plurality of cached object and type handlers formed as part of a run-time analysis of a plurality of items;
performing, at run-time, serialization based on the meta schema, wherein performing serialization includes referencing the cached plurality of handlers.

40. An automated system for in-situ deserialization of an item, the system comprising:
means for receiving the serialized item, the serialized item comprising at least one selected from a group consisting of an object and a type;
means for accessing a meta schema comprising a plurality of cached object and type handlers formed as part of a run-time analysis of a plurality of items from third party systems;
means for performing, at run-time, deserialization based on the serialization protocol and meta schema, wherein performing deserialization includes referencing the cached plurality of handlers.

41. An automated system for in-situ deserialization of an item, the system comprising:
at least one processor;
a user interface functioning via the at least one processor; and
a repository accessible by the at least one processor; wherein the at least one processor is configured to:
receive the serialized item, the serialized item comprising at least one selected from a group consisting of an object and a type;
access a meta schema comprising a plurality of cached object and type handlers formed as part of a run-time analysis of a plurality of items from third party systems;
via the at least one processor, perform, at run-time, deserialization based on the serialization protocol and meta schema, wherein performing deserialization includes referencing the cached plurality of handlers.

42. A computer program product comprising a computer readable medium having control logic stored therein for causing a computer to perform in-situ deserialization of an item, the control logic code for:
receiving the serialized item, the serialized item comprising at least one selected from a group consisting of an object and a type;
accessing a meta schema comprising a plurality of cached object and type handlers formed as part of a run-time analysis of a plurality of items from third party systems;
performing, at run-time, deserialization based on the serialization protocol and meta schema, wherein performing deserialization includes referencing the cached plurality of handlers.
